(19) United States
(12) Patent Application Publication
(10) Pub. No.: US 2024/0316580 A1
(43) Pub. Date: Sep. 26, 2024

(54) INTERSECTING NOZZLES ARRANGEMENT

(71) Applicant: Viviana London Limited, Hertfordshire (GB)

(72) Inventor: Michael Edwards, Letchworth Garden City (GB)

(21) Appl. No.: 17/605,276

(22) PCT Filed: Apr. 29, 2020
(86) PCT No.: PCT/GB2020/051049

§ 371 Date: Oct. 21, 2021

(30) Foreign Application Priority Data
Apr. 23, 2019 (GB) 1905645.6

(51) Int. Cl. B05B 7/08

(52) U.S. Cl. CPC B05B 7/0846

(57) ABSTRACT

A nozzle assembly (2) comprising a plurality of conduit means for delivering respective fluid substances from respective fluid containers to a plurality of corresponding outlet nozzles (6), wherein the plurality of outlet nozzles (6) are arranged about a central axis (8) of said assembly and to emit their respective fluids as converging streams to converge at a blending zone externally of the nozzle assembly (2).

This invention relates to a container and particularly to a container for fragrances which are sprayed.

Where it is desired to spray a mix of different fluids contained within the same container, it is possible to provide a mixing chamber prior to liquid being expelled from the container. However, a problem exists in that a proportion of the mixed fluids remains in the mixing chamber and consequently form a residual contaminant for a subsequent spray of a different mixture. All subsequent sprays are also contaminated if they are not a repeat spray of the first mixture.

According to the present invention, there is provided a nozzle assembly comprising a plurality of conduit means for delivering respective fluid substances from respective fluid containers to a plurality of corresponding outlet nozzles, wherein the plurality of outlet nozzles are arranged about a central axis of said assembly and to emit their respective fluids as converging streams to converge at a blending zone externally of the nozzle assembly.

Owing to this aspect, the outlet nozzles are arranged to emit their respective fluids towards the blending zone, where the fluids mix in the atmosphere externally of a spray container. This serves to eliminate the contamination of a residue mix that would be expelled with the next use.

Preferably, a main container unit includes the plurality of the fluid sub-containers defining a plurality of chambers for containing a liquid substance. Advantageously, a selecting mechanism is provided for selecting one or more of the fluid substances. In addition, a spray actuator is provided for dispensing one or more of the liquid substances from one or more of the respective sub-containers. Furthermore, it is advantageous if the sub-containers are removable from the main container unit so that the sub-containers are able to be replaced and recycled.

The external blending zone ensures mixing of a large majority of the sprayed fluids compared to an arrangement where the streams of fluid emitted from the nozzles did not converge on each other such that a relatively large proportion of the fluids would fail to mix in the atmosphere.

In order that the present invention can be completely understood, reference will now be made, by way of example only, to the accompanying drawings, in which:—

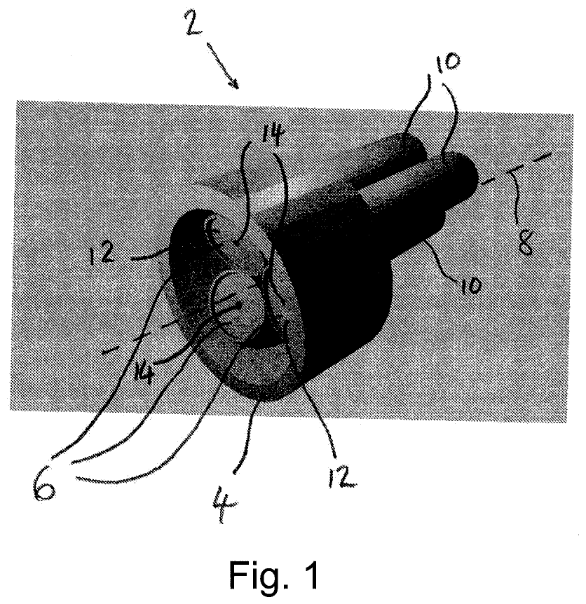

FIG. 1 shows a perspective view of a nozzle assembly, and

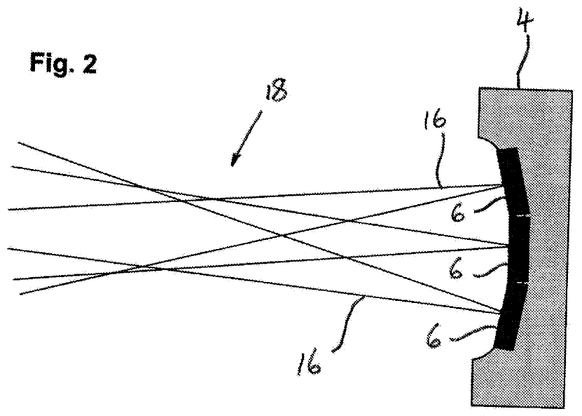

FIG. 2 shows a cross-sectional view of a nozzle assembly.

Referring to FIG. 1, a nozzle assembly 2 comprises an outer wall structure 4 bounding a crater-like indentation in which a plurality of outlet nozzles 6 are arranged about a central axis 8. Each of the plurality of outlet nozzles is connected to a plurality of respective conduit means 10, in the form of tubes, for delivering respective fluid substances from respective fluid containers stored internally of a main container unit (not shown).

Each outlet nozzle 6 in FIG. 1 has its outer face 12 angled inwardly toward the central axis 8. As a result, when fluid is emitted as a spray through openings 14 in the outlet nozzles 6 the emitted fluid streams converge towards each other toward a blending zone (see FIG. 2) externally of the nozzle assembly 2. In this way, there can be no residual contamination of a mixing chamber located internally of the main container unit.

Referring to FIG. 2, the fluid streams 16 of each of the outlet nozzles is schematically shown. In this version, one inner outlet nozzle 6 is co-axial with the central axis 8 with two outer outlet nozzles 6 having their faces 12 angled inwardly. The fluid streams emanate from the respective openings 14 and converge towards each other and mix at a blending zone 18 a small distance away from the nozzle assembly 2, that is proximal to the nozzle assembly. The distance between the outer faces 12 and the blending zone 18 is small, for example 15-20 mm, so that a majority of the fluid streams mix thus avoiding quantities of the individual fluids dispersing in the atmosphere without passing through the blending zone 18.

Advantageously, the nozzle assembly is a constituent part of a fragrance spray container and preferably an atmomisation type of spray device. Once a spray actuator on the container is operated, one or more selected liquid substances from the sub-containers are emitted as individual atomised spray streams through the outlet nozzles 6 toward the blending zone 18.

A selecting mechanism may comprise switch devices simply having ‘off’ and ‘on’ positions in order to select a fluid to be sprayed from a sub-container. The spray mechanism may therefore be arranged to emit a mix of fragrances consistently so that when switching between seven combinations of three sub-containers, the ratio of the mix at the blending zone 18 is substantially constant, so that with two fragrances selected as an example, the mixture will always smell substantially the same. The dosage of the individual fluids making up the mixture may be metred in such a way, either manually or electronically, that an unequal mix is achieved; for example 10% of a first fragrance, 50% of a second fragrance and 40% of a third fragrance, or metered equally.

1. A nozzle assembly for a container of fragrances comprising a plurality of conduit means for delivering respective fragrance fluid substances from respective fluid containers to a plurality of corresponding outlet nozzles, wherein the plurality of outlet nozzles are arranged about a central axis of said assembly and to emit their respective fragrance fluids as converging streams to converge at a fragrance blending zone externally of the nozzle assembly.

2. A nozzle assembly according to claim 1, and further comprising a main container unit including the plurality of conduit means of respective fragrance fluid sub-containers defining a plurality of chambers.

3. A nozzle assembly according to claim 2, and further comprising a selecting mechanism provided for selecting one or more fragrance fluid substances of the respective fluid sub-containers.

4. A nozzle assembly according to claim 1, and further comprising a spray actuator provided for dispensing one or more of the fragrance liquid substances from one or more of the respective sub-containers.

5. A nozzle assembly, according to claim 2 wherein the sub-containers are removable from the main container unit.

6. A nozzle assembly according to claim 1, wherein each outlet nozzle has its outer face angled inwardly toward the central axis.

7. A nozzle assembly according to claim 5 comprising three nozzles, wherein one nozzle is an inner outlet nozzle which is co-axial with the central axis and the two other nozzles are outer outlet nozzles, each having their faces angled inwardly toward the central axis.
